(19) United States
(12) Patent Application Publication
(10) Pub. No.: US 2012/0166194 A1
(43) Pub. Date: Jun. 28, 2012

(54) METHOD AND APPARATUS FOR RECOGNIZING SPEECH

(75) Inventors: Ho-Young JUNG, Daejeon (KR); Jeon-Gue PARK, Seoul (KR); Hoon CHUNG, Hongcheon-gun (KR)

(73) Assignee: Electronics and Telecommunications Research Institute, Daejeon-city (KR)

(21) Appl. No.: 13/335,854

(22) Filed: Dec. 22, 2011

(30) Foreign Application Priority Data
Dec. 23, 2010 (KR) 10-2010-0133957

(51) Int. Cl. G10L 15/10; G10L 15/04

(52) U.S. Cl. 704/238; 704/240; 704/E15.005; 704/E15.015

(57) ABSTRACT

Disclosed herein are an apparatus and method for recognizing speech. The apparatus includes a frame-based speech recognition unit, a segment division unit, a segment feature extraction unit, a segment speech recognition performance unit, and a combination and synchronization unit. The frame-based speech recognition unit extracts frame speech feature vectors from a speech signal, and performs speech recognition on frames of the speech signal using the frame speech feature vectors and a frame-based probability model. The segment division unit divides the speech signal into segments. The segment feature extraction unit extracts segment speech feature vectors around a boundary between the segments. The segment speech recognition performance unit performs speech recognition on the segments of the speech signal using the segment speech feature vectors and a segment-based probability model. The combination and synchronization unit combines results of the speech recognition for the frames with results of the speech recognition for the segments.

### CROSS REFERENCE TO RELATED APPLICATION

This application claims the benefit of Korean Patent Application No. 10-2010-0133957, filed on Dec. 23, 2010, which is hereby incorporated by reference in its entirety into this application.

### BACKGROUND OF THE INVENTION

1. Technical Field

The present invention relates generally to a method and apparatus for recognizing speech and, more particularly, to a method and apparatus for recognizing speech, which take into consideration the long-term features of speech, reflecting temporal characteristics, as well as the short-term features of the speech during the performance of speech recognition, thereby improving the overall performance of speech recognition.

2. Description of the Related Art

In general, speech recognition includes the recognition of general commands issued by a speaker and the recognition of natural language. Speech recognition methods being widely used currently are based on a one-stream method of extracting feature vectors at a fixed frame rate and generating a probability model thereof. In general, in the speech recognition field, Mel-Frequency Cepstral Coefficients (MFCCs) are being widely used. MFCCs use energy in frequency bands divided according to the Mel scale, and means speech feature vectors (so-called speech feature parameters) that represent speech issued by a user. Furthermore, a Hidden Markov Model (HMM) using MFCCs is being used as a probability model that represents a speech signal. Although the above-described method is applied to currently commercialized speech recognition systems, it is problematic in that the performance of recognition is deteriorated when a variety of types of variations exist.

### SUMMARY OF THE INVENTION

Accordingly, the present invention has been made keeping in mind the above problems occurring in the prior art, and an object of the present invention is to provide a method and apparatus for recognizing speech, which determine the long-term features of speech, reflecting temporal characteristics, as well as the short-term features of the speech and then perform speech recognition, thereby improving the overall performance of speech recognition. That is, the present invention is intended to improve the performance of speech recognition in the fields of speech recognition applications in which a variety of phonetic variations exist.

Furthermore, another object of the present invention is to provide a method and apparatus for recognizing speech, which can improve the performance of speech recognition using synchronization in the division among phonemes in connection with the division among phonemes using a frame-based probability model and the division among phonemes using a segment-based probability model.

In order to accomplish the above object, the present invention provides a method of recognizing speech, including extracting frame speech feature vectors from a speech signal; performing speech recognition on frames of the speech signal using the frame speech feature vectors and a frame-based probability model; dividing the speech signal into segments each of which is longer than each of the frames in terms of time; extracting segment speech feature vectors around a boundary between the segments; performing speech recognition on the segments of the speech signal using the segment speech feature vectors and a segment-based probability model; and combining results of the speech recognition for the frames with results of the speech recognition for the segments.

The dividing may include calculating a distance measure between adjacent first and second frame speech feature vectors, and, if the calculated distance measure is greater than a predetermined value, dividing the speech signal into the segments using a point between the first and second frame speech feature vectors as a point for the division between the segments.

The distance measure may be a variation in the speech signal.

The method may further include synchronizing the results of the speech recognition for the frames with the results of the speech recognition for the segments.

The synchronizing may include applying a Dynamic Bayesian Network (DBN)-based Switching Linear Dynamic Model (SLDM) to a portion where the frame-based probability model is combined with the segment-based probability model in order to synchronize the results of the speech recognition for the frames with the results of the speech recognition for the segments.

The extracting segment speech feature vectors may include extracting the segment speech feature vectors by performing Principal Component Analysis (PCA) and trajectory information feature extraction on the segments of the speech signal.

The segment-based probability model may be a Gaussian model based on the segment speech feature vectors.

The frame-based probability model may be a Hidden Markov Model (HMM).

Additionally, in order to accomplish the above object, the present invention provides an apparatus for recognizing speech, including a frame-based speech recognition unit for extracting frame speech feature vectors from a speech signal, and performing speech recognition on frames of the speech signal using the frame speech feature vectors and a frame-based probability model; a segment division unit for dividing the speech signal into segments each of which is longer than each of the frames in terms of time; a segment feature extraction unit for extracting segment speech feature vectors around a boundary between the segments; a segment speech recognition performance unit for performing speech recognition on the segments of the speech signal using the segment speech feature vectors and a segment-based probability model; and a combination and synchronization unit for combining results of the speech recognition obtained by the frame-based speech recognition unit with results of the speech recognition obtained by the segment speech recognition performance unit.

The segment division unit may calculate a distance measure between adjacent first and second frame speech feature vectors, and, if the calculated distance measure is greater than a predetermined value, divide the speech signal into the segments using a point between the first and second frame speech feature vectors as a point for the division between the segments.

The distance measure may be a variation in the speech signal.

The combination and synchronization unit may synchronize the results of the speech recognition obtained by the frame-based speech recognition unit with the results of the speech recognition obtained by the segment speech recognition performance unit.

The combination and synchronization unit may apply a DBN-based SLDM to a portion where the frame-based probability model is combined with the segment-based probability model in order to synchronize the results of the speech recognition for the frames with the results of the speech recognition for the segments.

The segment extraction unit may extract the segment speech feature vectors by performing PCA and trajectory information feature extraction on the segments of the speech signal.

The segment-based probability model may be a Gaussian model based on the segment speech feature vectors.

The frame-based probability model may be an HMM.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating a method of recognizing speech according to the present invention;

FIG. 2 is a diagram illustrating the process of extracting frame speech feature vectors and segment speech feature vectors;

FIG. 3 is a diagram illustrating an example of the operation of combining a frame-based probability model with a segment-based probability model;

FIG. 4 is a diagram illustrating a method of synchronizing the results of the speech recognition based on a frame-based probability model with the results of the speech recognition based on a segment-based probability model; and

FIG. 5 is a block diagram illustrating the configuration of an apparatus for recognizing speech according to the present invention.

### DESCRIPTION OF THE PREFERRED EMBODIMENTS

Reference now should be made to the drawings, throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

A method of recognizing speech according to the present invention will now be described.

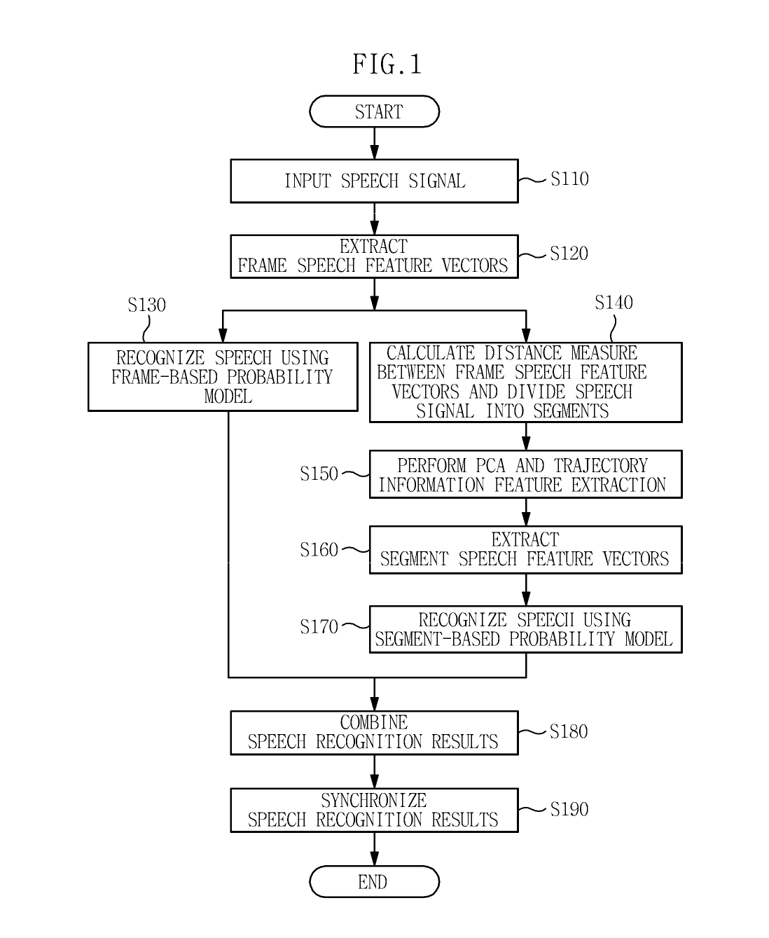

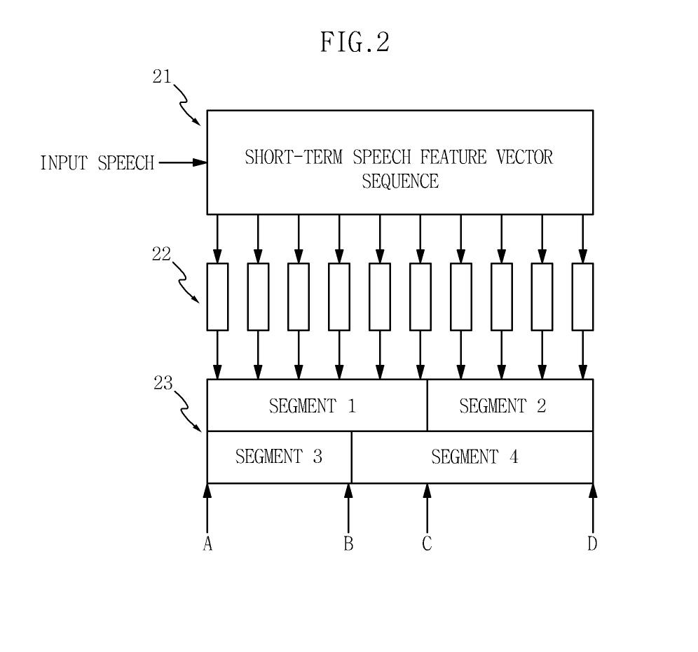

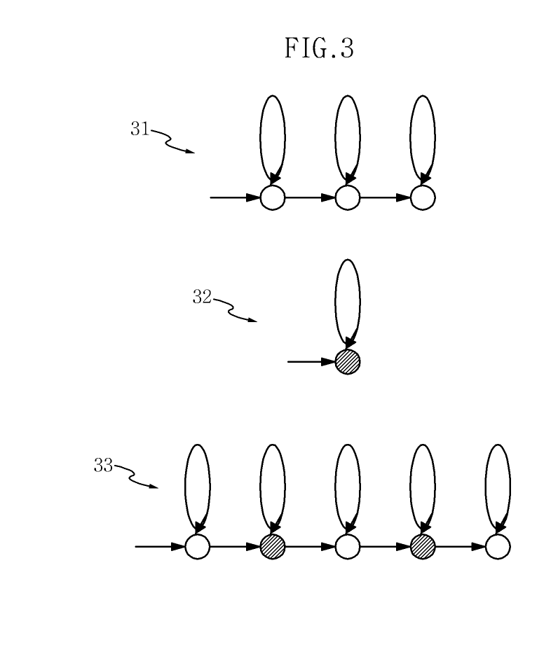

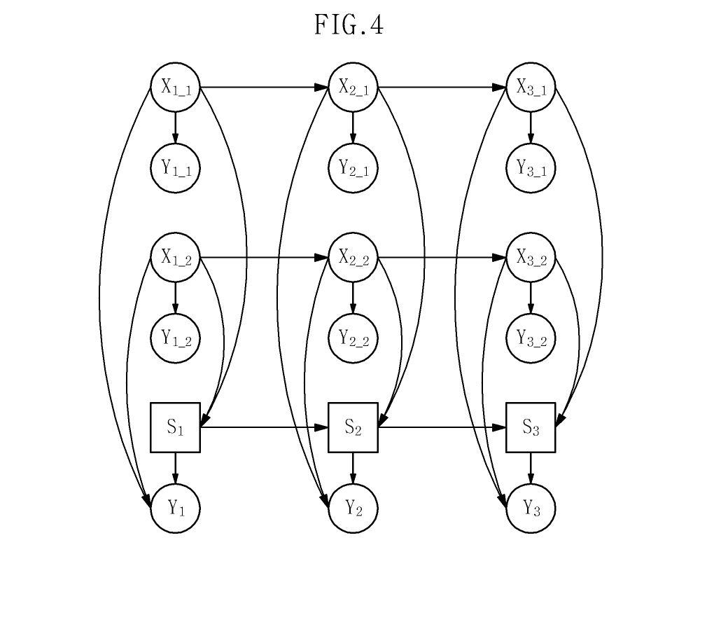

FIG. 1 is a flowchart illustrating a method of recognizing speech according to the present invention. FIG. 2 is a diagram illustrating the process of extracting frame speech feature vectors and segment speech feature vectors. FIG. 3 is a diagram illustrating an example of the operation of combining a frame-based probability model with a segment-based probability model. FIG. 4 is a diagram illustrating a method of synchronizing the results of the speech recognition based on a frame-based probability model with the results of the speech recognition based on a segment-based probability model.

Referring to FIG. 1, in the method of recognizing speech according to the present invention, a speech signal is received as an input at step S110.

Thereafter, at step S120, frame speech feature vectors are extracted from the speech signal received at step S110. Here, the frame speech feature vectors are feature vectors that are extracted at a fixed frame rate in order to reflect the short-term features of the speech signal.

Speech recognition is performed on the frames of the speech signal using the frame speech feature vectors and a frame-based probability model at step S130. Here, the frame-based probability model may be an HMM.

The speech signal is divided into segments each of which is longer than each frame in terms of time at S140. In this case, the distance measure between adjacent predetermined first and second frame speech feature vectors of a plurality arranged frame speech feature vectors is calculated. If the calculated distance measure is larger than a predetermined value, the speech signal is divided into segments using a point between the first and second frame speech feature vectors as a point of division between the segments. In this case, the distance measure may be a variation in the speech signal over time. Meanwhile, each of the segments may correspond to a phoneme.

Thereafter, Principal Component Analysis (PCA) and trajectory information feature extraction are performed on the boundary for the division of the speech signal into the segments at step S150, and segment speech feature vectors are extracted at step S160. Here, the segment speech feature vectors are long-term feature vectors that are extracted to reflect the temporal characteristics of the speech signal.

Referring to FIG. 1 together with FIG. 2, at step S120, a short-term speech feature vector sequence 21, that is, a frame speech feature vector sequence, is extracted from the input speech signal. In this case, the speech signal is divided into a plurality of frame speech feature vectors 22. At step S140, the input speech signal is divided into a plurality of segments 23. In this case, each of the segments 23 is longer than each of the frames in terms of time. The segments 23 may be segment 1 and segment 2, or segment 3 and segment 4. That is, the distance measures of points b and c between the adjacent ones of the frame speech feature vectors 22 are calculated, and a point having the greater distance measure may be set as a point for the division between the segments. That is, as in the example of FIG. 2, variable-length segment boundary information is extracted from the frame-based features of the speech signal, and the segments are divided based on the boundary information.

Speech recognition is performed on the segments using the segment speech feature vectors and a segment-based probability model at step S170. Here, the segment-based probability model may be a segment speech feature vector-based Gaussian model.

At step S180, the results of the speech recognition for the frames obtained at step S130 are combined with the results of the speech recognition for the segments obtained at step S170.

FIG. 3 illustrates an example in which a frame-based probability model based representation 31 obtained at step S130 is combined with a segment-based probability model based representation 32 obtained at step S170. In the representation of phonemes, a frame-based probability model, that is, an HMM, is represented using three state models. Meanwhile, a segment-based probability model is represented using a Gaussian model based on a segment feature for each phoneme. A multi-stream probability model may be constructed by distinguishing and combining the above two types of probability models using streams. The configuration 33 of FIG. 3 in which two streams have been combined with each other is formed such that segment-based probability models are inserted among the states of the HMM structure. In this case, if a corresponding segment-based model is determined when the state of a specific phoneme of the short-term feature-based HMM representation is determined, the probability values of two streams are combined with each other. Otherwise only the HMM probability value is utilized.

Furthermore, at step S190, the results of the speech recognition for the frames at step S130 may be synchronized with the results of the speech recognition for the segments at step S170. In order to synchronize the results of the speech recognition for the frames with the results of the speech recognition for the segments, a Dynamic Bayesian Network (DBN)-based Switching Linear Dynamic Model (SLDM) may be applied to the portion where the results of the speech recognition for the frames are combined with the results of the speech recognition for the segments.

When the frame-based feature based HMM and the segment-based probability model are combined into a stream, a problem may arise in that the phoneme alignment information of the respective streams varies. When the model of each stream performs phoneme alignment, information about division among phonemes varies, and therefore a problem occurs in the combination of the probability values of the respective streams. When non-synchronization occurs due to the difference in information about division in terms of time, there is the strong possibility of the combination of the probability values based on the combination of streams making the start and end of each phoneme incorrect. Furthermore, this may result in the deterioration of the performance of the overall speech recognition. In order to solve this problem, it is necessary to allow the temporal difference in the division among phonemes attributable to two streams. This allows the probability model of the frame-based stream to move along the optimum path, and to be combined with the segment-based probability model when a segment-based feature appears, thereby processing the difference in the boundary between phonemes. As the simplest method, a method of setting a threshold value in advance so that the temporal difference in information about division is processed in the same manner for a predetermined length may be taken into account. However, this method is problematic in that the threshold value must vary depending on the conditions. Accordingly, the present invention proposes a DBN-based method in order to solve the problem of non-synchronization in the division among phonemes. That is, the present invention employs a switching dynamic model that adjusts the synchronization of the results of the two streams based on a data association DBN that is used to process heterogeneous inputs.

FIG. 4 illustrates a structure in which a frame-based probability model stream, that is, an HMM stream, and a segment-based probability model stream are combined with each other using an asynchronous DBN. The problem of non-synchronization in the division among phonemes is solved by applying a Switching Linear Dynamic Model (SLDM) to the portion where the state information of the HMM stream for the frame-based features is combined with the state information of the segment-based probability model stream for the segment-based features. In the processing of the portion in which non-synchronization exists, the state information of search paths having strong possibilities is ascertained in the HMM representation. Thereafter, the probability value for the state of each path in the segment-based probability model is obtained, and then a weight is applied thereto, thereby calculating a final observation probability model. The weight may be obtained from a state distribution based on the data that is used when the HMM representation and the segment model are trained. The final observation probability that combines the frame-based features with the segment-based features based on an SLDM is determined using the following Equation 1:

P(Yₜ=y|Sₜ=i,Yₜ_{_{—}}₁,Yₜ_{_{—}}₂)=N(y;w₁U(SₜXₜ_{_{—}}₁)yₜ_{_{—}}₁+w₂U(SₜXₜ_{_{—}}₂)yₜ_{_{—}}_{₂}+μᵢσᵢ) (1)

Equation 1 indicates that a model for a final observation feature vector y into which the frame-based feature and the segment-based feature are combined is constructed and the probabilities for the observed frame-based features and segment-based features are calculated. In this case, model state information is obtained at the feature yₜ_{_{—}}₁, y_{t—}₂ of the streams, and the optimum state is determined based on the HMM stream. Thereafter, a final probability value is obtained using a Gaussian model of the observation feature vector y of the determined state and a weight for the determined states of two streams. By doing so, even when the two streams are not synchronized with each other, the probability values of the segment streams are combined with each other based on the state information obtained from the HMM stream. Accordingly, when the two models have the same state information, a great probability value is generated, and therefore more reliable results can be obtained.

The configuration and operation of an apparatus 500 for recognizing speech according to the present invention will now be described.

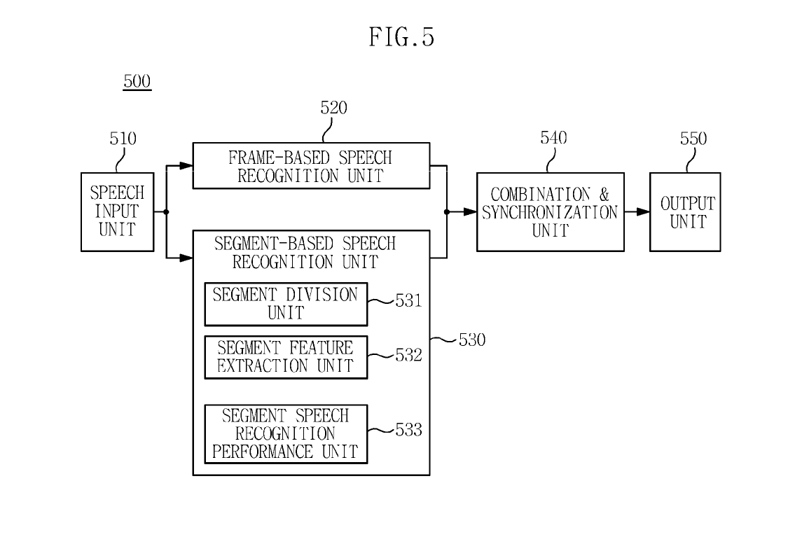

FIG. 5 is a block diagram illustrating the configuration of the apparatus 500 for recognizing speech according to the present invention.

Referring to FIG. 5, the apparatus 500 for recognizing speech according to the present invention includes an input unit 510, a frame-based speech recognition unit 520, a segment-based speech recognition unit 530, a combination and synchronization unit 540, and an output unit 550.

The speech input unit 510 receives speech from a speaker or the like in the form of a speech signal.

The frame-based speech recognition unit 520 extracts frame speech feature vectors from the speech signal. Furthermore, the frame-based speech recognition unit 520 performs speech recognition on the frames of the speech signal using the frame speech feature vectors and a frame-based probability model. Here, the frame-based probability model may be an HMM.

The segment-based speech recognition unit 530 includes a segment division unit 531, a segment feature extraction unit 532, and a segment speech recognition performance unit 533.

The segment division unit 531 divides the speech signal into segments each of which is longer than each of the frames in terms of time. In this case, the segment division unit 531 calculates a distance measure between the adjacent predetermined first and second frame speech feature vectors of a plurality of arranged frame speech feature vectors. Furthermore, the segment division unit 531, if the calculated distance measure has a value greater than a predetermined value, divides the speech signal into segments using a point between the first and second frame speech feature vectors as a point of division between the segments. Here, the distance measure may be a variation in the speech signal over time. The segment feature extraction unit 532 extracts segment speech feature vectors around the boundary between the segments. The segment speech recognition performance unit 533 performs speech recognition on the segments using the segment speech feature vectors and a segment-based probability model. Here, the segment-based probability model may be a segment speech feature vector-based Gaussian model.

The combination and synchronization unit 540 combines the results of the speech recognition obtained by frame-based speech recognition unit 520 with the results of the speech recognition obtained by the segment speech recognition performance unit 530. Furthermore, the combination and synchronization unit 540 synchronizes the results of the speech recognition obtained by the frame-based speech recognition unit 520 with the results of the speech recognition obtained by the segment speech recognition performance unit 530. In this case, in order to synchronize the results of the speech recognition obtained by the frame-based speech recognition unit 520 with the results of the speech recognition obtained by the segment speech recognition performance unit 530, the combination and synchronization unit 540 may apply a DBN-based SLDM to the portion where the results of the speech recognition obtained by frame-based speech recognition unit 520 are combined with the results of the speech recognition obtained by the segment speech recognition performance unit 530.

The output unit 550 outputs the results of the speech recognition that are generated by the combination and synchronization unit 540.

Accordingly, the present invention provides a method and apparatus for recognizing speech, which determine the long-term features of speech, reflecting temporal characteristics, as well as the short-term features of the speech and then perform speech recognition, thereby improving the overall performance of speech recognition. Accordingly, the present invention can improve the performance of speech recognition in the fields of speech recognition applications in which a variety of phonetic variations exist.

Furthermore, the present invention provides a method and apparatus for recognizing speech, which can improve the performance of speech recognition by overcoming the problem of non-synchronization in the division among phonemes in connection with the division among phonemes using a frame-based probability model and the division among phonemes using a segment-based probability model.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of recognizing speech, comprising:
extracting frame speech feature vectors from a speech signal;
performing speech recognition on frames of the speech signal using the frame speech feature vectors and a frame-based probability model;
dividing the speech signal into segments each of which is longer than each of the frames in terms of time;
extracting segment speech feature vectors around a boundary between the segments;
performing speech recognition on the segments of the speech signal using the segment speech feature vectors and a segment-based probability model; and
combining results of the speech recognition for the frames with results of the speech recognition for the segments.

2. The method as set forth in claim 1, wherein the dividing comprises calculating a distance measure between adjacent first and second frame speech feature vectors, and, if the calculated distance measure is greater than a predetermined value, dividing the speech signal into the segments using a point between the first and second frame speech feature vectors as a point for the division between the segments.

3. The method as set forth in claim 2, wherein the distance measure is a variation in the speech signal.

4. The method as set forth in claim 1, further comprising synchronizing the results of the speech recognition for the frames with the results of the speech recognition for the segments.

5. The method as set forth in claim 4, wherein the synchronizing comprises applying a Dynamic Bayesian Network (DBN)-based Switching Linear Dynamic Model (SLDM) to a portion where the frame-based probability model is combined with the segment-based probability model in order to synchronize the results of the speech recognition for the frames with the results of the speech recognition for the segments.

6. The method as set forth in claim 1, wherein the extracting segment speech feature vectors comprises extracting the segment speech feature vectors by performing Principal Component Analysis (PCA) and trajectory information feature extraction on the segments of the speech signal.

7. The method as set forth in claim 1, wherein the segment-based probability model is a Gaussian model based on the segment speech feature vectors.

8. The method as set forth in claim 1, wherein the frame-based probability model is a Hidden Markov Model (HMM).

9. An apparatus for recognizing speech, comprising:
a frame-based speech recognition unit for extracting frame speech feature vectors from a speech signal, and performing speech recognition on frames of the speech signal using the frame speech feature vectors and a frame-based probability model;
a segment division unit for dividing the speech signal into segments each of which is longer than each of the frames in terms of time;
a segment feature extraction unit for extracting segment speech feature vectors around a boundary between the segments;
a segment speech recognition performance unit for performing speech recognition on the segments of the speech signal using the segment speech feature vectors and a segment-based probability model; and
a combination and synchronization unit for combining results of the speech recognition obtained by the frame-based speech recognition unit with results of the speech recognition obtained by the segment speech recognition performance unit .

10. The apparatus as set forth in claim 9, wherein the segment division unit calculates a distance measure between adjacent first and second frame speech feature vectors, and, if the calculated distance measure is greater than a predetermined value, divides the speech signal into the segments using a point between the first and second frame speech feature vectors as a point for the division between the segments.

11. The apparatus as set forth in claim 10, wherein the distance measure is a variation in the speech signal.

12. The apparatus as set forth in claim 9, wherein the combination and synchronization unit synchronizes the results of the speech recognition obtained by the frame-based speech recognition unit with the results of the speech recognition obtained by the segment speech recognition performance unit.

13. The apparatus as set forth in claim 12, wherein the combination and synchronization unit applies a DBN-based SLDM to a portion where the frame-based probability model is combined with the segment-based probability model in order to synchronize the results of the speech recognition for the frames with the results of the speech recognition for the segments.

14. The apparatus as set forth in claim 9, wherein the segment extraction unit extracts the segment speech feature vectors by performing PCA and trajectory information feature extraction on the segments of the speech signal.

15. The apparatus as set forth in claim 9, wherein the segment-based probability model is a Gaussian model based on the segment speech feature vectors.

16. The apparatus as set forth in claim 9, wherein the frame-based probability model is an HMM.
